(19) United States
(12) Patent Application Publication
(10) Pub. No.: US 2005/0199484 A1
(43) Pub. Date: Sep. 15, 2005

(54) Ozone generator with dual dielectric barrier discharge and methods for using same

(76) Inventor: Franek Olstowski, Houston, TX (US)

Correspondence Address: ROBERT W STROZIER, P.L.L.C, PO BOX 429, BELLAIRE, TX, 77402-0429, US

(21) Appl. No.: 11/055,583

(22) Filed: Feb. 10, 2005

Related U.S. Application Data
(60) Provisional application No. 60/543,432, filed on Feb. 10, 2004.

(51) Int. Cl. B01J 19/08; B01J 19/12

(52) U.S. Cl. 204/176; 422/186.07

(57) ABSTRACT

A new and novel ozone generator with a dual dielectric barrier discharge design is disclosed where high-purity ozone is generated and whose concentration can be varied over a wide range. The simplified design of the ozone generator cell possesses a gas inlet and outlet connected to an annular, sealed dielectric gas envelope that supports both inner and outer electrodes that do not come into contact with the gas. The design eliminates the need for gaskets, o-rings or other methods applied to seal the ozone cell and reduces problems associated with potential interaction resulting from material compatability issues. The applied high voltage is provided by a simple self-resonating, push-pull oscillating circuit whose efficiency is optimized through application of an appropriate impedance matching device. The ozone is concentration is adjusted by varying the pulse width duty cycle of the applied voltage and gas flow rate. The design configuration of the ozone generating cell also eliminates the need for forced air or liquid cooling by natural convective air currents and conductive means.

### RELATED APPLICATIONS

This application claims provisional priority to U.S. Provisional Patent Application Ser. No. 60/543,432 filed 10 Feb. 2004.

### BACKGROUND OF THE INVENTION

1. Field of the Invention

The present invention relates to a high-efficiency ozone generator adapted to produce variable concentrations of high-purity ozone at a constant flow rate and where an oxygen containing gas does not come into direct contact with electrodes in the ozone generator during ozone generation.

More particularly, the present invention relates to an ozone generator including a pulse width controlled, self-resonating high frequency, power supply and an ozone generation cell that comprises an elongated torus-shaped member or an annular region of an elongated member having a gas inlet and a gas outlet and an outer electrode attached to or mounted on an outside surface of the member of region and an inner electrode attached to or mounted on an inner surface the member or region, where ozone is generated in an interior of the member or region between an inner wall and an outer wall of the member or region and where the walls comprise a dielectric material.

2. Description of the Related Art

Ozone is a highly reactive triatomic form of oxygen (O₃), which predominantly exists in its more stable diatomic molecular form (O₂). It is also known as activated or allotropic oxygen and is a natural occurring substance. Ozone is present in higher concentrations in the upper levels of the atmosphere due to photo-dissociation of O₂ by UV solar radiation and is also produced by lightning and/or electrostatic discharges in thunderstorms.

Numerous ozone generator designs have been developed over the years that allow ozone to be synthetically manufactured from oxygen, or an oxygen-containing gas. These prior art ozone generators utilize optical processes such as UV or microwave radiation to photo-dissociation oxygen (O₂) or utilize electronic processes such as sparks, arcs, plasmas and corona discharges to dissociate oxygen and form ozone.

Regardless of the method by which it is produced, ozone eventually decomposes to diatomic oxygen through recombination with co-produced oxygen atoms or through reaction with other ozone molecules. Ozone has an estimated half-life of several minutes under ambient conditions. Increasing temperatures cause ozone to decompose more rapidly and ozone cannot be produced or exist at temperatures in excess of 200° C.

Uses of Ozone

Because ozone is an extremely reactive molecule and a powerful oxidizing agent, it is useful in oxidation reactions including deodorizing and/or detoxifying airborne or water borne pollutants. Ozone is also very effective in destroying or killing microorganisms, spores, viruses and cysts. As a result, ozone is routinely utilized as an alternative to chlorine addition for purifying drinking water, treating waste water and disinfecting swimming pools.

When utilized in the presence of short wavelength UV light, ozone is additionally beneficial in the destruction of undesired surface contaminants on silicon wafers and microchips within the semiconductor industry. Efficient surface decontamination of silicon wafers is routinely accomplished through a photo-dissociation process involving high-energy UV radiation that decomposes trace solvent or hydrocarbon molecules that react with ozone to form oxygenated species such as H₂O and CO₂ byproducts, which are then removed from the surface by traditional means.

Ozone is also utilized in several analytical techniques such as sulfur and/or nitrogen chemiluminescence detection methods. The basic principle of these techniques is a reaction between ozone and an ozone reactive analyte to form an electronically excited species. The electronically excited species then decay to their corresponding ground states emitting photons having characteristic wavelengths depending on the species and energy lost in the transition. Light-sensitive detectors, such as photomultiplier tubes (PMTs), channel-plate multipliers (CPMs) or high-sensitivity avalanche photodiodes (APDs), convert the emitted photons to an electrical current that is typically found to be directly proportional to the concentration of an element present in the analyte so that a numeric concentration of that the element in a sample can be determined.

Problems with the Prior Art

Most ozone generators contain two separate electrodes connected to a high-voltage pulsed DC or AC electrical field generator. These electrodes are typically separated by a single dielectric barrier with a gas channel or “air gap” that allows oxygen or an oxygen-containing gas to flow between the electrodes. An applied electrical field with sufficient voltage to charge the dielectric material and to exceed the breakdown voltage of the adjacent gas channel creates an electrical discharge or high-temperature plasma through the gas. The discharge or high-temperature plasma causes dissociation of oxygen and breaks the O—O bond of molecular oxygen. The produced oxygen atoms can then either recombine or more often react with diatomic oxygen molecules (O₂) to form triatomic oxygen molecules (O₃) or ozone.

Besides creating ozone, the electrical sparks can create microscopic pits or ablation on metallic electrode surfaces due to high instantaneous temperatures caused by the current released during each electric discharge. This process can cause electrode material to sputter from the electrode surface allowing trace amounts of metal atoms or metal oxides to mix with the ozone. The amount of metal contamination can increase with increasing discharge current and with subsequent increasing electrode temperature. The electrode temperature, material and any trace metals present in the dielectric utilized, may impact the degree of metallic contamination.

In many applications, metal contaminants may not present any significant problems. However, it is well established that the presence of trace metals on the surface of silicon wafers is known to be seriously detrimental in chip manufacturing. Additionally, metal contaminants in generated ozone used in highly sensitive analytical applications can play a detrimental role in these applications.

U.S. Pat. No. 4,970,056 details a plate type generator including a quartz or other dielectric layers protecting the electrodes from discharge ablation, but recommends cementing the quartz layer directly to the electrode surfaces at elevated temperatures to avoid cracking of the quartz layer during operation due to tension caused from differences in coefficients of thermal expansion.

U.S. Pat. Nos. 5,503,809 and 6,270,733 disclose designs that require the use of o-rings or gaskets to form gas-tight seals between various components of the ozone generating cell. Such o-ring or gaskets are susceptible to ozone attack and degradation, which can lead to ozone contamination and leaks.

Therefore, there is a need in the art for an ozone generator having simple design that creates high purity ozone having no contaminants. There is also a need in the art for ozone generators that are reliable, inexpensive, efficient and capable of producing variable concentrations of ozone over a wide range of ozone concentrations for use in ozone concentration-dependent applications. These is also a need in the art for ozone cell designs that eliminate the need for additional components to establish gas-tight seals and reduces potential material interaction, reactivity and compatibility issues. There is also a need in the art for ozone generators that do not require external cooling such as forced air or recirculating liquid (e.g., water) cooling.

### SUMMARY OF THE INVENTION

The present invention provides an ozone generator including of an elongated gas cell an having annular region, a gas inlet and a gas outlet. The annular region includes an inner wall and an outer wall. The generator also includes an inner electrode attached to an inner surface of the inner wall or inserted into an annulus defined by the annular region so that the inner electrode is in close proximity to the inner wall or in direct contact with the inner wall. The generator also includes an outer electrode surrounding a portion of an outer surface of the outer wall of the annular region of the cell. The generator also includes a high-voltage power supply, generally, having a periodic or pulsed output profile, preferably having a high-frequency substantially pure sine wave output profile connected to the electrodes. The inner and outer electrodes preferably have an overlapping zone; however, the inner and outer electrodes can be disposed with a lateral gap between a leading edge of one electrode and a trailing edge of the other electrode. The walls of the annular region form a duel dielectric barrier between the gas and the electrodes and the cell isolates the electrode from the gas flowing through the cell.

The present invention also provides an apparatus including an ozone generator of this invention adapted to produce a constant or variable amount of high-purity ozone, where the variable amount can be dynamically controlled.

The present invention also provides an apparatus including a sample supply unit, an optional sample separation unit, an optional sample component conversion unit, a reaction chamber, an ozone generator of this invention, a detector unit and an analyzer unit. The supply unit supplies a sample to the apparatus. The reaction chamber includes an interior where sample components react with ozone to produce electronically excited species. The detector detects light emitted by the electronically excited species and the analyzer calculates concentrations of detected elements in the sample.

The present invention also provides an apparatus including a sample supply unit, an optional sample separation unit, an optional sample component conversion unit, a detection chamber, an ozone generator of this invention, a detector unit and an analyzer unit. The supply unit supplies a sample to the apparatus. The ozone generator generates sufficient ozone to reduce, substantially eliminate or eliminate interfering molecules in the sample or component stream to be analyzed, while insufficient ozone to adversely affect detection of the desired sample atomic component. The detection chamber includes an interior where the desired sample atomic components is detected via fluorescence, chemiluminescence, absorbance or transmittance. The detector generators an output signal corresponding to the detection process and the analyzer converts the detector signal into concentrations of detected elements in the sample.

The present invention also provides a method for generating ozone include the step of supplying an oxygen-containing gas to the gas inlet of an ozone generator of this invention. As the oxygen-containing gas passes through the generator, pulse-width controlled electric signals are supplied to the power supply. The power supply then produces time-varied bursts of high-voltage across the electrodes producing periodic, short duration discharges through the oxygen-containing gas. The short duration pulses generate a desired concentration of ozone. The frequency and pulse width of the pulses or the applied duty cycle frequency across the electrodes control an average ozone concentration at a given oxygen gas flow rate. The method can also include the step of varying the concentration of generated ozone by varying the frequency and pulse width of the pulses according to a pre-established protocol or dynamically depending on the intended use or requirement of the system. The method can also include the step of using impedance matching to tune the resonance frequency of the ozone generator circuitry to the ozone generating cell for efficient and maximal energy transfer to the electrodes and ultimately to the oxygen-containing gas passing through the generator.

The present invention also provides a method for detecting ozone induced chemiluminescence including the step of generating ozone using an ozone generator of this invention: After generation, the ozone is contacted with an ozone reactive analyte in a reaction chamber including a detector to generate electronically excited species. Light emitted by the electronically excited species is then detected by the detector producing an output signal. The output signal is then forwarded to an analyzer that converts the detector signal into a concentration of an element in the analyte.

The present invention also provides a method for detecting SO₂ fluorescence including the step of generating ozone using an ozone generator of this invention. After generation, the ozone is supplied to a gas stream containing SO₂ and an interfering concentration of NO at an effective ozone concentration, which is sufficient to convert all or substantially all (greater than about 90%) of the interfering NO to non-interfering NO₂. The ozone treated gas is then exposed to UV excitation light generated by a UV excitation light source to produce electronically excited SO₂ species, some of which subsequently fluoresce. The detector detects the fluorescent light and produces an output signal. The output signal is then forwarded to an analyzer that converts the detector signal into a concentration of a sulfur in the gas stream.

The present invention also provides a method for purifying a waste stream including the step of supplying a sufficient amount of ozone from an ozone generator of this invention to convert all or substantially all (greater than 90%) of all noxious oxidizable contaminants into less noxious or benign oxidized components. The method can also include the step of varying the concentration of the generated ozone according to a pre-established protocol or dynamically depending on a concentration of noxious oxidizable components in the waste stream. Dynamic control can be achieved via electrical feedback circuitry keyed to measured noxious contaminants in the treated waste stream. The waste stream can be solid, liquid or gas or mixtures or combinations thereof.

### BRIEF DESCRIPTION OF THE DRAWINGS

The invention can be better understood with reference to the following detailed description together with the appended illustrative drawings in which like elements are numbered the same:

FIGS. 1A&B depict an end view and a cross-sectional view of a preferred embodiment of an ozone generator of this invention;

FIG. 1C depicts a center cut view of a preferred embodiment of an ozone generator of this invention;

FIG. 1D depicts a center cut view of another preferred embodiment of an ozone generator of this invention;

FIGS. 1E&F an end view and a cross-sectional view of another preferred embodiment of an ozone generator of this invention;

FIG. 1G depicts a center cut view of another preferred embodiment of an ozone generator of this invention;

FIG. 2 depicts a block diagram of an apparatus including an ozone generator of this invention;

FIG. 3A depicts a block diagram of a preferred embodiment of an apparatus including an ozone generator of this invention;

FIG. 3B depicts a block diagram of another preferred embodiment of an apparatus including an ozone generator of this invention;

FIG. 3C depicts a plot generated ozone concentration versus duty cycle and pulse width;

FIGS. 3D-F depict oscilloscope plots of the actual form of the pulses associated with the 10%, 50% and 90% duty cycle of FIG. 3B showing the high frequency component;

FIGS. 3G&H depict oscilloscope plots of the high frequency component of FIGS. 3C-E having a frequency of 17.5 kHz;

FIG. 4A depicts a schematic of a preferred embodiment of a pulse width controlled, high frequency, power supply circuit of this invention; and

FIG. 4B depicts an expanded view of the LT-1764 component of the circuit of FIG. 4A.

### DETAILED DESCRIPTION OF THE INVENTION

Ozone exists in concentrations from about 10-50 ppb (parts per billion) at sea level and although essential for absorbing skin damaging UV radiation from the sun, ozone is very toxic to humans and sensitive tissues. Concentrations of 100 ppb over an 8-hour period of time are considered detrimental and exposure of 50 ppm over 30 minutes would likely be fatal. However, trace levels have been found useful in deodorizing applications, as well as destroying many airborne pollutants and bacteria. Therefore, an ozone generating system that is capable of effectively controlling ozone concentration at safe, yet effective levels would be highly beneficial.

The inventor has found that an ozone generator can be constructed that is capable of producing adjustable concentrations of high purity ozone so that the amount of ozone generated can be optimized for a given application. The inventor has also found that with an appropriate ozone detector and electronic feedback circuitry, the ozone generator of this invention can be designed to automatically and dynamically adjust the ozone concentration to meet instantaneous ozone demand.

Ozone generators typically fall into two general categories: (1) plate type generators and (2) tubular type generators. These two types of ozone generators are essentially capacitors (two electrodes with an insulator interposed therebetween) that store energy. As an electrical field is applied across the electrodes, a charge is built up and stored between the electrodes. When the dielectric strength of the insulating gas medium disposed between the electrodes is exceeded, a current path is created. The resulting dielectric breakdown in the medium allows the stored energy to be discharged through the medium via the path. The stored energy (W) in such a discharge device is given by the equation:
W=½CV²
where C is an equivalent capacitance of the discharge device and V is the applied electrode voltage. It can be seen from the above equation that if the capacitance is increased, then the stored energy is also increased. The equivalent capacitance of a particular discharge device is given by the equation:
C=ε₀εₛS/l
where ε₀=8.854×10⁻¹² (the dielectric constant of a vacuum), εₛ is the specific dielectric constant of the insulating medium or material, S is the surface area of the electrode and l is the distance or gap between the electrodes.

The capacitance or capacitive reactance of the ozone generating cell is compensated by utilizing an appropriate impedance matching device, such as an inductor, to tune the circuit to the resonant frequency of the high-voltage supply through the equation:

$$f = \frac{1}{2 π \sqrt{LC}}$$

where f is the applied frequency, C is the load capacitance and L is the circuit inductance.

The ozone generator of this invention is of an elongated tubular design that includes two electrodes separated by two concentrically-oriented dielectric layers having equal wall thicknesses and different diameters, which forms a part of a closed, hollow geometrical shape having an inlet and an outlet through which oxygen or an oxygen containing gas can be passed. Although any frequency can be used, one preferred frequency range is between about 60 Hz and about 40 kHz. Another preferred frequency range is between about 10 kHz and about 20 kHz. Another preferred frequency range is between about 15 kHz and about 20 kHz, which is best power transfer with minimal audible noise. The voltage range is determined by the ozone cell geometry, dielectric wall thickness and annular gap. One preferred voltage range is between about 14 kV and about 15 kV peak to peak.

One advantage of the ozone generators of this invention is that the electrodes are not directly exposed to generated ozone or to ozone generating conditions. This advantage prevents metal contamination of the generated ozone providing a higher purity of ozone can be produced and reduces electrode ablation and decomposition. Although an elongated torus is a preferred closed hollow tubular member, the geometry can be of any desired geometrical shape, provided that the electrodes are positioned to support electric discharges through the gas flowing through the interior of the closed hollow tubular member from the inlet to the outlet. Regardless of the geometrical shape, the closed hollow tubular member or closed annular hollow member, the electrodes are not ever in direct contract with the generated ozone or in direct contact with the ozone generating conditions.

Because the ozone generators of this invention include a three component dielectric medium, (i.e., two ceramic layers and a gas layer) between the two electrodes, the overall dielectric constant of the medium is increased, and more stored energy must be accumulated before the required breakdown voltage is reached. Also because each electrode has an associated dielectric layer, an instantaneous current within each discharge streamer is limited due to localized rapid depletion of electron charge density within the dielectric layer. The subsequent discharge and induced dissociation of diatomic oxygen in the oxygen-containing gas is thus comprised of microscopic filament discharges, which contain less heat within individual discharge streamers than equivalent spark or arc discharges. One of the benefits to the designs of this invention is lower conversion of diatomic nitrogen (N₂) to oxides of nitrogen (i.e., NO, NO_{2,}, etc.) which are both noxious, as well as potentially detrimental to analytical applications, as they can interfere with accurate detection of species measured by certain analytical instrumentation.

Because the ozone generators of this invention are capable of producing variable concentrations of ozone in the oxygen-containing gas that passes through the ozone generators, the ozone generators of this invention are ideally suited for analytical applications that would benefit from variable concentrations of ozone. One such application involves the detection of sulfur dioxide (SO₂) by UV fluorescence spectrometry.

In SO₂ UV fluorescence spectrometry, an excitation light source that produces a single high-energy UV wavelength or a high-energy range of UV wavelengths is used to excite SO₂ into an electronically excited state. Many of the electronically excited SO₂ molecules then emit the absorbed energy rapidly in the form of a fluorescent light decaying back to their ground state in a process known as fluorescence. Light exiting the excitation chamber is optically filtered to only allow the fluorescing wavelengths to pass in order to minimize detector response to the excitation wavelength or other wavelengths of light.

However, interference from nitric oxide (NO) is a common problem with this method as NO has absorption bands in the same general region and more critically the NO fluorescent spectrum lies within the fluorescing wavelength range of SO₂. Careful selection of optical band pass filters can reduce NO interference of SO₂ fluorescence, but it cannot be totally eliminated by optical filtering. In addition, optical filtering of NO fluorescence results in a corresponding reduction in SO₂ sensitivity.

In atmospheric monitoring of SO₂, NO is often also present complicating effective SO₂ monitoring. In fact, SO₂ and NO are common by-products formed from high-temperature combustion of fuels due to the oxidation of nitrogen and/or sulfur containing molecules in the fuel.

It has been found that the addition of small or trace amounts of ozone to a gas sample containing both SO₂ and NO will selectively convert the NO to electronically excited NO₂. Although the excited NO₂ molecules can then undergo ozone induced chemiluminescence, the NO₂ chemiluminescence emission spectrum, which begins in the near-IR, lies outside the wavelength region of SO₂ fluorescence and as a result produces almost no detectable interference. Because ozone selectively reacts with NO, the addition of trace amount of ozone to such gases results in no loss in SO₂ detector sensitivity. Therefore, the addition of trace amount of ozone to a sample gas at, or prior to, the inlet of the fluorescence chamber has been found to successfully eliminate NO interference in SO₂ UV fluorescence detection.

Unfortunately, ozone effectively absorbs UV radiation so any ozone present in the fluorescent chamber merely absorbs the UV excitation energy required for SO₂ fluorescence. Therefore, concentration of zone in excess of that required to oxidize the NO to NO₂ merely acts to reduce SO₂ sensitivity emissions, adversely affecting the stability and accuracy of resulting SO₂ measurements. Because NO is typically present in such as gas sample in a parts-per-million (ppm) concentration, whether in atmospheric monitoring applications, or as a byproduct of oxidative fuels analysis, only trace amounts of ozone are required to completely convert interfering NO to non-interfering NO₂.

In such an application, the ozone generator of the invention is adjusted to produced just enough ozone to destroy the interfering NO so that SO₂ detection sensitivity is not adversely affected. Because the ozone generators of this invention can include feed back circuitry designed to adjust the ozone output dynamically, the ozone generators of this invention can be designed to dynamically adjust a concentration of ozone to optimize SO₂ fluorescence improving stability, reliability and sensitivity of SO₂ fluorescence detection without NO interference.

Suitable Components and Materials

Suitable dielectric materials out of which the closed hollow tubular member can be constructed include, without limitation, any gas impermeable dielectric material. Exemplary examples such impermeable dielectric materials include, without limitation, quartz, high-purity quartz, fused-silica, alumina ceramics, silica ceramics, glass or other suitable or equivalent materials. The hollow tubular member can also be constructed out of a gas permeable dielectric material coated with an impermeable dielectric coating. Preferably, the closed hollow tubular members are constructed out of high-purity quartz or fused-silica.

Electrodes suitable for use in this invention include, without limitation, thin, sheets of a conductive material having good electrical and thermal conductive properties. Conductive materails including, without limitation, metals, conductive ceramic composites, conductive organic composites, conductive polymers, or the like. Exemplary examples of conductive metals include, without limitation, aluminum, aluminum alloys, copper, copper alloys (brass, bronze, etc.), silver, silver alloys, gold, gold alloys, and other highly conductive metals. The preferred metals are copper and copper alloys, with brass being especially preferred.

The preferred electrode designs for use in this invention are either solid base rods or brass tubing, which are readily available in a variety of diameters and/or wall thicknesses and possess the desired electrical and thermally conductive properties. One preferred inner electrode design is an appropriately sized brass tube having a laterally extended slit so that the tube can be slightly compressed prior to insertion in to the annulus of the annular region of the cell allowing the electrode, typically the anode, to make direct contact and to conform to the inner wall of the annular region of the ozone generating cell. In most of the preferred embodiments, the outer electrode, typically the cathode, is a brass tube or sleeve having a laterally extending slit so that the brass tube can be fitted over the outer wall of the cell between the gas inlet and the gas outlet. The sleeve then conforms to the outer surface of the outer wall so that the cathode makes direct contract with the outer wall of dielectric material. The sleeve also includes a tightening device associated with the sleeve to act as a retaining clamp forcing the sleeve into direct contact with the outer surface of the outer wall of the cell between the outlet and inlet.

Using tubular electrodes allows internal heat generated from the internal portion of the ozone generating cell to be transferred through conduction before being dissipated through radiative means. Externally generated heat is primarily dissipated through radiation, but some thermal conduction occurs along the outside dielectric surface, increasing radiative surface area. If the ozone cell is mounted in a vertical orientation, additional cooling is obtained from natural air convection currents that flow through the inside and across outside surfaces, similar to that obtained with a chimney. In all of the preferred embodiment, the inner electrode extends out past end of the annulus to increase thermal conduction of heat and radiative transfer of the conducted thermal energy.

### DETAILED DESCRIPTION OF THE DRAWINGS

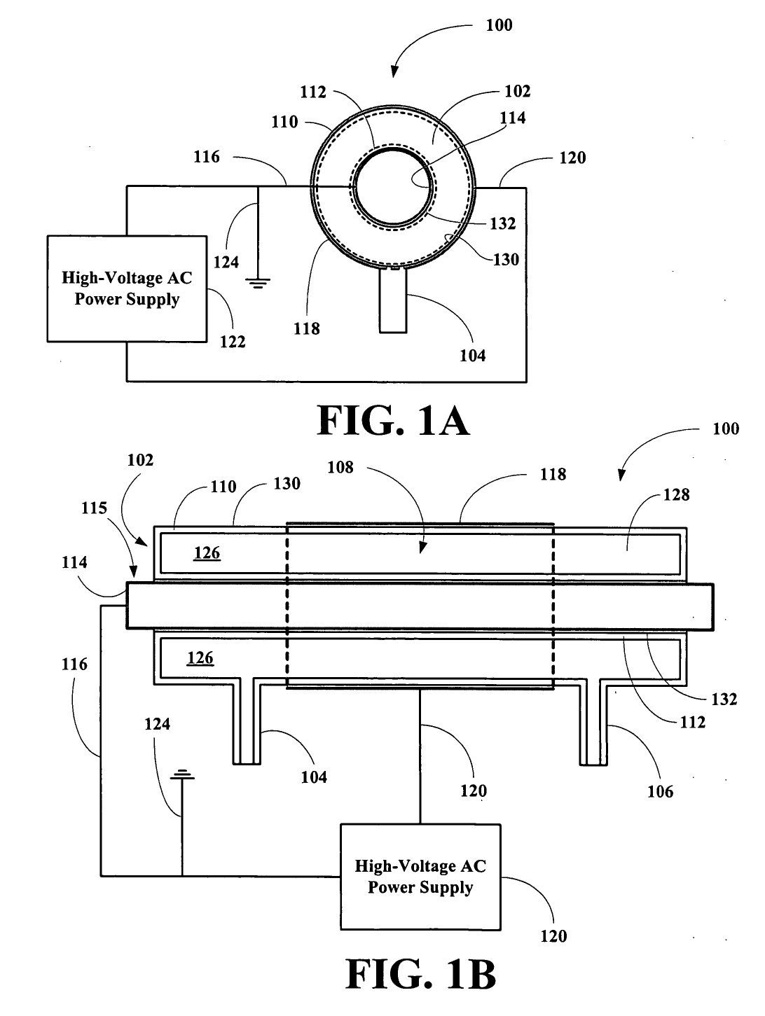

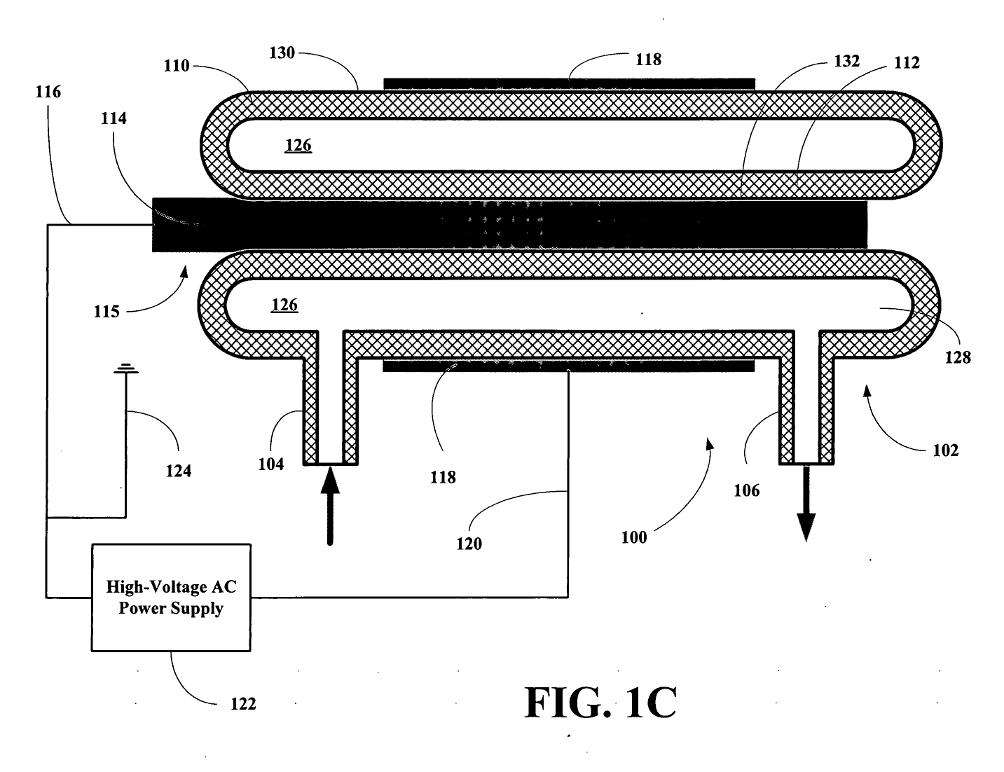

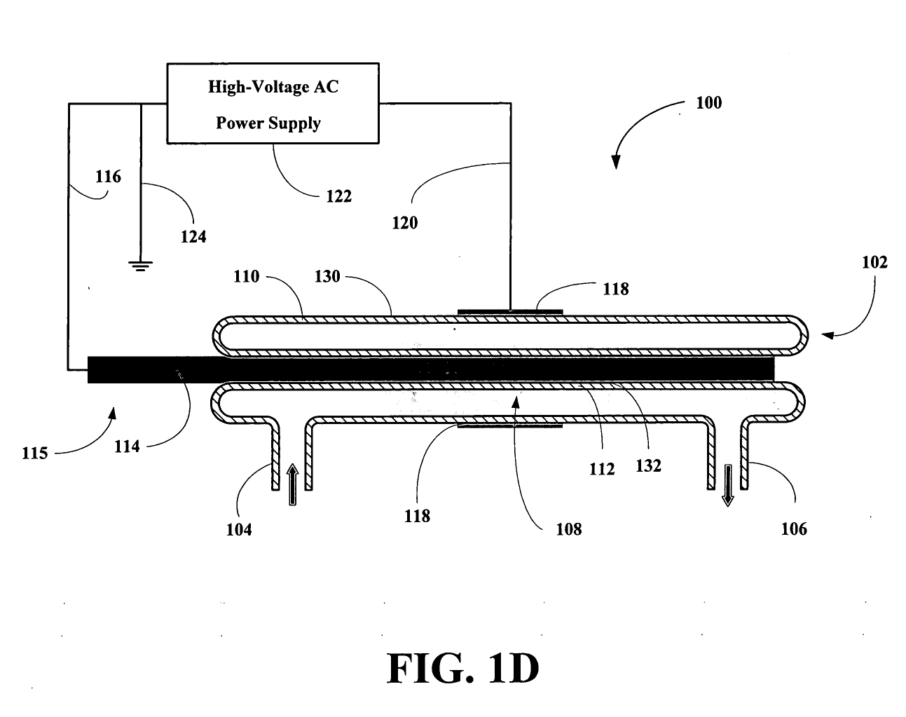

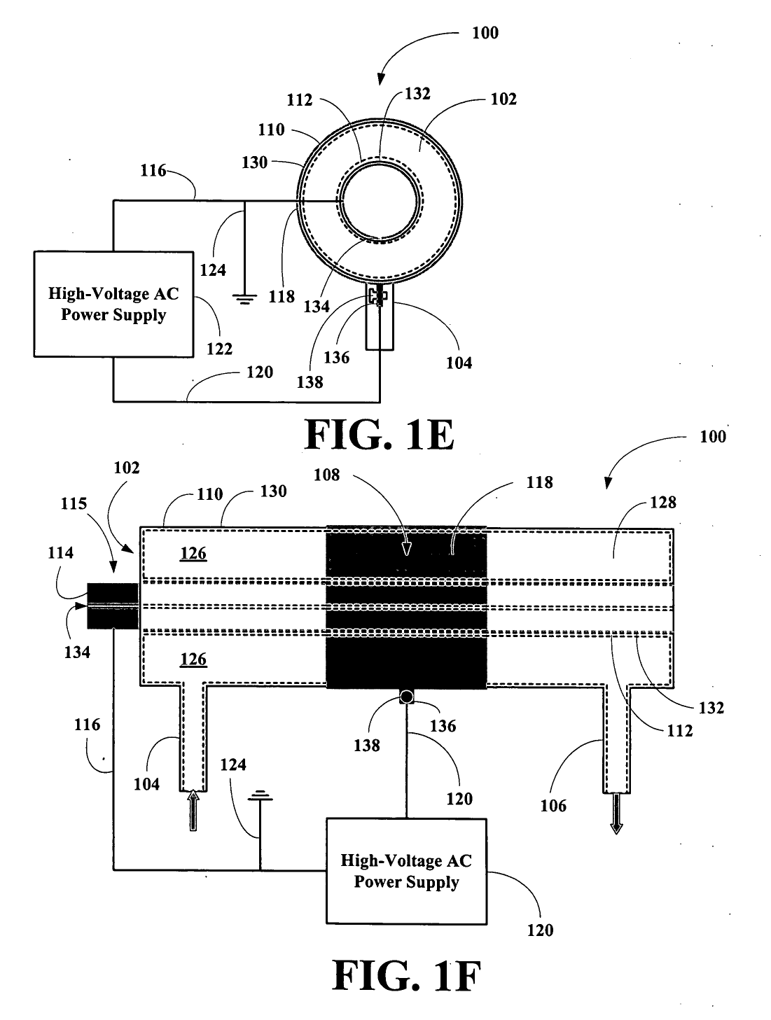

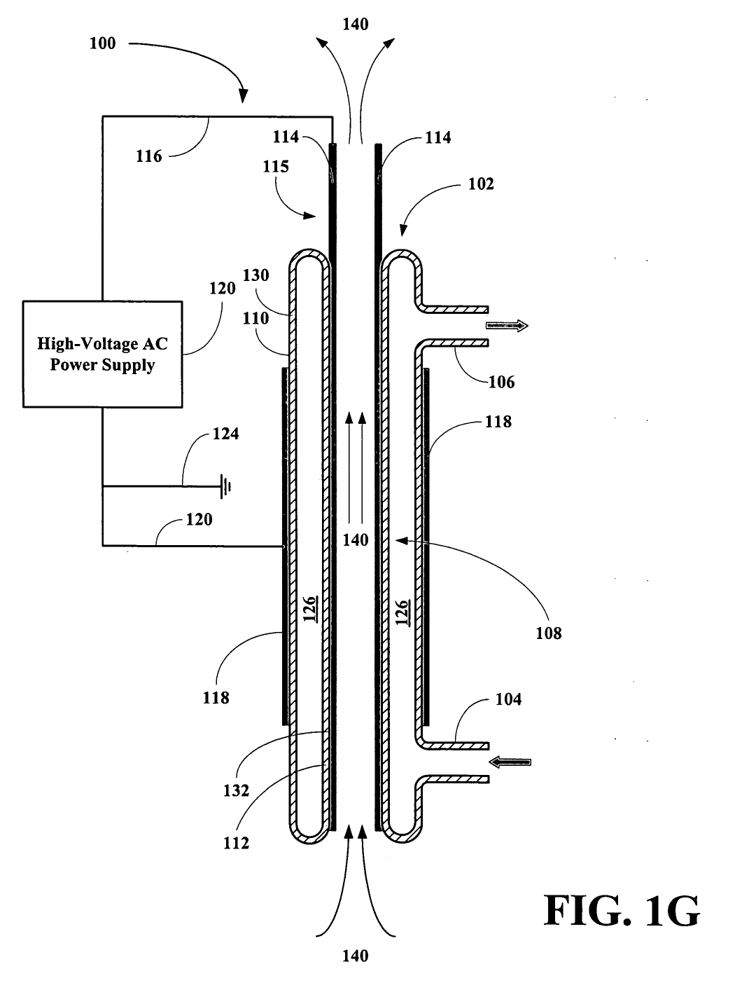

Referring now to FIGS. 1A-B, a preferred embodiment of an ozone generator of this invention, generally 100, is shown to include a cell 102 comprising an elongated torus having a gas inlet 104, a gas outlet 106, an annular region 108, an outer wall 110, and an inner wall 112, where the annular region 108 comprises the outer portion of the cell 102 between the inlet 104 and the outlet 106. The generator 100 also includes a tubular inner electrode 114 having a portion 115 that extend out past the cell 102 and an inner electrode lead 116 and a sleeve-type outer electrode 118 having an outer electrode lead 120. The leads 116 and 120 are connected to a high-voltage AC power supply 122 which also includes a ground 124. The cell 102 can be constructed of any dielectric material capable of containing an oxygen-containing gas and being relatively unreactive with ozone. The cell 102 provides a structure comprising two electrodes 114 and 118 and an dielectric medium interposed therebetween. The dielectric medium includes the outer wall 110 of the cell 102, the inner wall 112 of the cell 102 and an gas 126 in an interior 128 of the cell 102. Thus, each of the electrode 114 and 118 is isolated from the gas 126 by one of the walls 110 and 112 of the cell 102, where the walls 110 and 112 comprise dielectric layer associated with the electrodes 114 and 118, respectively. Unlike prior are devices, the cell 102 does not include any gaskets or seals and does not require any complicated electrode fabrication. The electrodes are simply placed in contact with their respectively wall of the cells. Generally, the electrodes are fitted onto or into the cells so that the electrodes are in direct contact an outer surface 130 of the outer wall 110 and an inner surface 132 of the inner wall 112 of the cell 102.

Referring now to FIG. 1C, another preferred embodiment of an ozone generator of this invention, generally 100, is shown to include a cell 102 comprising an elongated torus having a gas inlet 104, a gas outlet 106, an annular region 108, an outer wall 110, and an inner wall 112, where the annular region 108 comprises the outer portion of the cell 102 between the inlet 104 and the outlet 106. The generator 100 also includes a solid cylindrical inner electrode 114 having a portion 115 that extend out past the cell 102 and an inner electrode lead 116. The generator 100 also includes a sleeve-type outer electrode 118 having an outer electrode lead 120, where the outer electrode 118 surrounds a major portion of the annular region 108. The leads 116 and 120 are connected to a high-voltage AC power supply 122 which also includes a ground 124. The cell 102 can be constructed of any dielectric material capable of containing an oxygen-containing gas and being relatively unreactive with ozone. The cell 102 provides a structure comprising two electrodes 114 and 118 and an dielectric medium interposed therebetween. The dielectric medium includes the outerwall 110 of the cell 102, the innerwall 112 of the cell 102 and an gas 126 in an interior 128 of the cell 102. Thus, each of the electrode 114 and 118 is isolated from the gas 126 by one of the walls 110 and 112 of the cell 102, where the walls 110 and 112 comprise dielectric layer associated with the electrodes 114 and 118, respectively. Unlike prior are devices, the cell 102 does not include any gaskets or seals and does not require any complicated electrode fabrication. The electrodes are simply placed in contact with their respectively wall of the cells. Generally, the electrodes are fitted onto or into the cells so that the electrodes are in direct contact an outer surface 130 of the outer wall 110 and an inner surface 132 of the inner wall 112 of the cell 102.

Referring now to FIG. 1D, another preferred embodiment of an ozone generator of this invention, generally 100, is shown to include a cell 102 comprising an elongated torus having a gas inlet 104, a gas outlet 106, an annular region 108, an outer wall 110, and an inner wall 112, where the annular region 108 comprises the outer portion of the cell 102 between the inlet 104 and the outlet 106. The generator 100 also includes a solid cylindrical inner electrode 114 having a portion 115 that extend out past the cell 102 and an inner electrode lead 116. The generator 100 also includes a sleeve-type outer electrode 118 having an outer electrode lead 120, where the outer electrode 118 surrounds a small portion of the annular region 108. The leads 116 and 120 are connected to a high-voltage AC power supply 122 which also includes a ground 124. The cell 102 can be constructed of any dielectric material capable of containing an oxygen-containing gas and being relatively unreactive with ozone. The cell 102 provides a structure comprising two electrodes 114 and 118 and an dielectric medium interposed therebetween. The dielectric medium includes the outerwall 110 of the cell 102, the innerwall 112 of the cell 102 and an gas 126 in an interior 128 of the cell 102. Thus, each of the electrode 114 and 118 is isolated from the gas 126 by one of the walls 110 and 112 of the cell 102, where the walls 110 and 112 comprise dielectric layer associated with the electrodes 114 and 118, respectively. Unlike prior are devices, the cell 102 does not include any gaskets or seals and does not require any complicated electrode fabrication. The electrodes are simply placed in contact with their respectively wall of the cells. Generally, the electrodes are fitted onto or into the cells so that the electrodes are in direct contact an outer surface 130 of the outer wall 110 and an inner surface 132 of the inner wall 112 of the cell 102.

Referring now to FIGS. 1E&F, another preferred embodiment of an ozone generator of this invention, generally 100, is shown to include a cell 102 comprising an elongated torus having a gas inlet 104, a gas outlet 106, an annular region 108, an outer wall 110, and an inner wall 112, where the annular region 108 comprises the outer portion of the cell 102 between the inlet 104 and the outlet 106. The generator 100 also includes a tubular inner electrode 114 having a portion 115 that extend out past the cell 102, an inner electrode lead 116 and a laterally extending slit 134, where the slit 134 allows the inner electrode 114 to be compressed prior to insertion into the cell 102 to facilitate contact between the electrode 114 and an inner surface 132 of the inner wall 112. The generator 100 also includes a sleeve-type outer electrode 118 having clamping tabs 136 including a threaded aperture therethrough (not shown), a tightening member 138, and an outer electrode lead 120, where the outer electrode 118 surrounds a small portion of the annular region 108. The tabs 136 and the tightening member 138 (a screw or bolt) are adapted facilitate contact between the electrode 118 and an outer surface 130 of the outerwall 110. The leads 116 and 120 are connected to a high-voltage AC power supply 122 which also includes a ground 124. The cell 102 can be constructed of any dielectric material capable of containing an oxygen-containing gas and being relatively unreactive with ozone. The cell 102 provides a structure comprising two electrodes 114 and 118 and an dielectric medium interposed therebetween. The dielectric medium includes the outer wall 110 of the cell 102, the inner wall 112 of the cell 102 and an gas 126 in an interior 128 of the cell 102. Thus, each of the electrode 114 and 118 is isolated from the gas 126 by one of the walls 110 and 112 of the cell 102, where the walls 110 and 112 comprise dielectric layer associated with the electrodes 114 and 118, respectively. Unlike prior are devices, the cell 102 does not include any gaskets or seals and does not require any complicated electrode fabrication. The electrodes are simply placed in contact with their respectively wall of the cells. Generally, the electrodes are fitted onto or into the cells so that the electrodes are in direct contact the outer surface 130 of the outer wall 110 and the inner surface 132 of the inner wall 112 of the cell 102.

Referring now to FIG. 1G, another preferred embodiment of an ozone generator of this invention, generally 100, is shown which is vertically disposed, while the previous embodiments where horizontally disposed. The generator 100 includes a cell 102 comprising an elongated torus having a gas inlet 104, a gas outlet 106, an annular region 108, an outer wall 110, and an inner wall 112, where the annular region 108 comprises the outer portion of the cell 102 between the inlet 104 and the outlet 106. The generator 100 also includes a tubular inner electrode 114 having a portion 115 that extend out past the cell 102 and an inner electrode lead 116. The generator 100 also includes a sleeve-type outer electrode 118 having an outer electrode lead 120, where the outer electrode 118 surrounds a major portion of the annular region 108. The leads 116 and 120 are connected to a high-voltage AC power supply 122 which also includes a ground 124. The cell 102 can be constructed of any dielectric material capable of containing an oxygen-containing gas and being relatively unreactive with ozone. The cell 102 provides a structure comprising two electrodes 114 and 118 and an dielectric medium interposed therebetween. The dielectric medium includes the outerwall 110 of the cell 102, the innerwall 112 of the cell 102 and an gas 126 in an interior 128 of the cell 102. Thus, each of the electrode 114 and 118 is isolated from the gas 126 by one of the walls 110 and 112 of the cell 102, where the walls 110 and 112 comprise dielectric layer associated with the electrodes 114 and 118, respectively. Unlike prior are devices, the cell 102 does not include any gaskets or seals and does not require any complicated electrode fabrication. The electrodes are simply placed in contact with their respectively wall of the cells. Generally, the electrodes are fitted onto or into the cells so that the electrodes are in direct contact an outer surface 130 of the outer wall 110 and an inner surface 132 of the inner wall 112 of the cell 102. The vertical disposition of the ozone cell 102 of this embodiment and the tubular inner electrode 114 provide for improved cooling of the cell 102 during operation. Because the hollow tubular inner electrode 114 is vertically disposed, the electrode 114 can support convective flow 140 in a manner similar to a chimney.

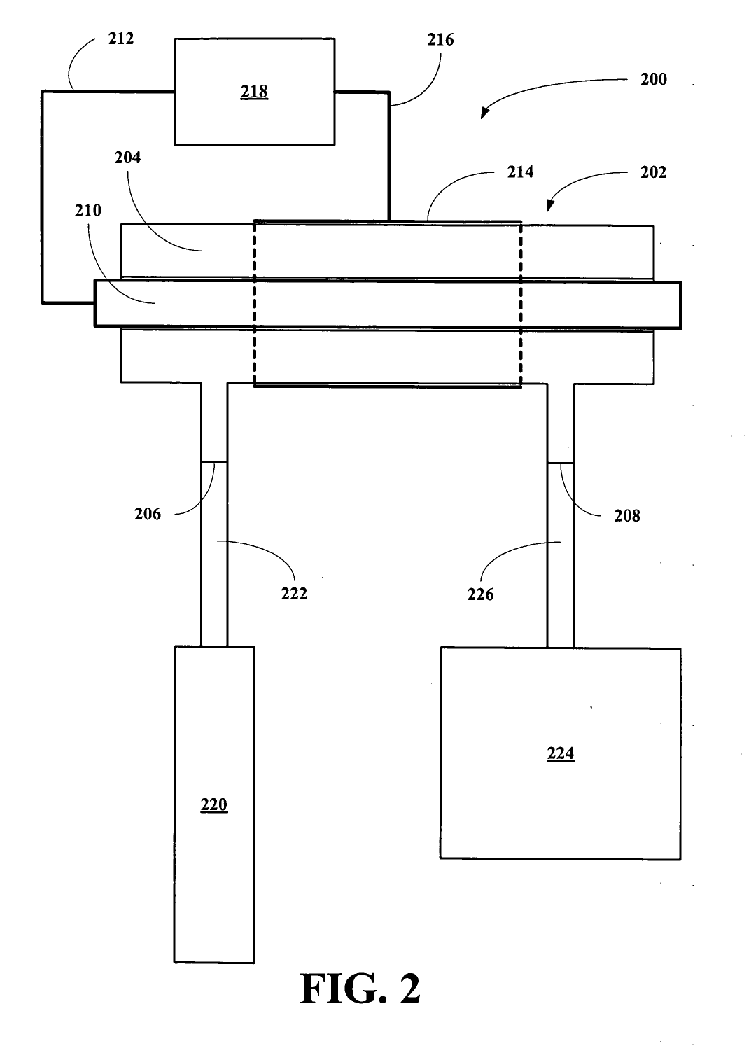

Referring now to FIG. 2, a preferred embodiment of an apparatus of this, generally 200, is shown to include an ozone generator of this invention 202. The generator 202 includes an elongated torus-shaped cell 204 having a gas inlet 206 and a gas outlet 208, an inner electrode 210 having an inner electrode lead 212 and an outer electrode 214 having an outer electrode lead 216. The electrode lead 212 and 216 are connected to a variable frequency sine wave generator 218. The gas inlet 206 is attached to a gas supply system 220 for supplying an oxygen-containing gas to the cell 204 via a gas conduit 222. The gas outlet 208 is attached to an ozone receiving system 224 via a second gas conduit 226. The ozone receiving system 224 can be an analytical instrument, a water purifier, an integrated circuit manufacturing unit or any other system for which ozone is needed.

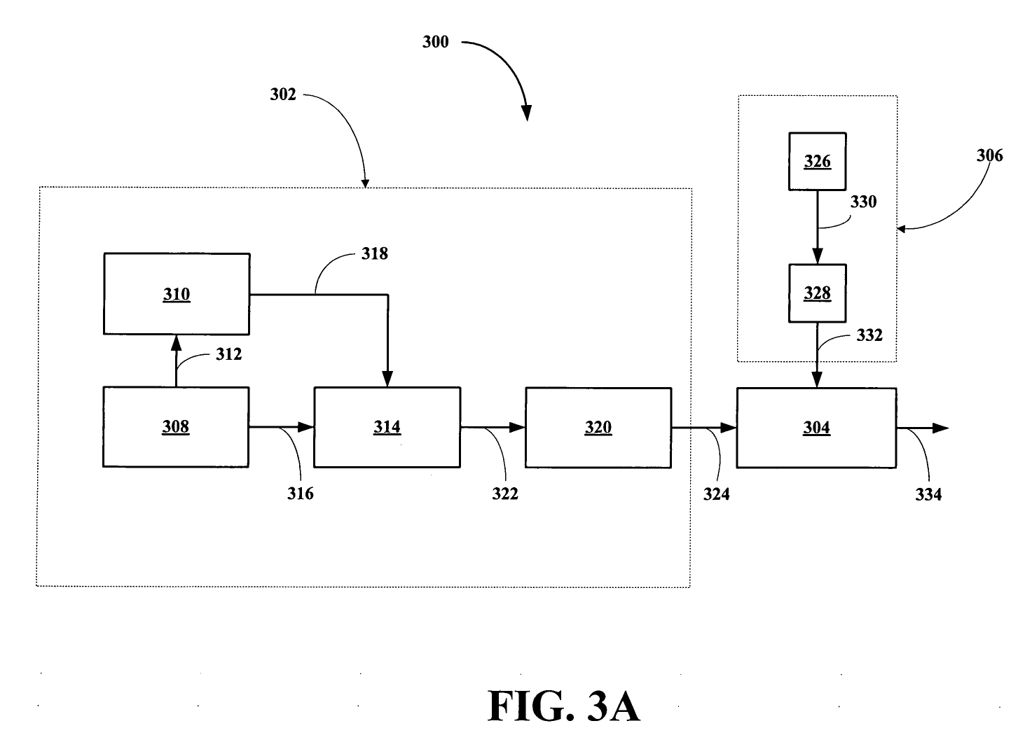

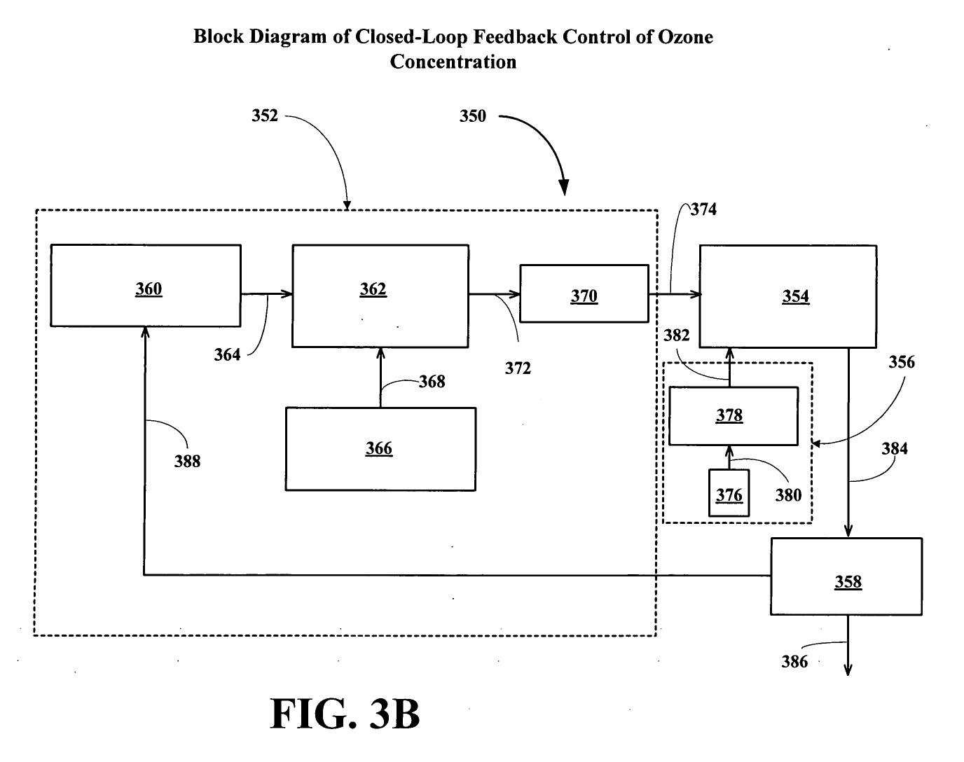

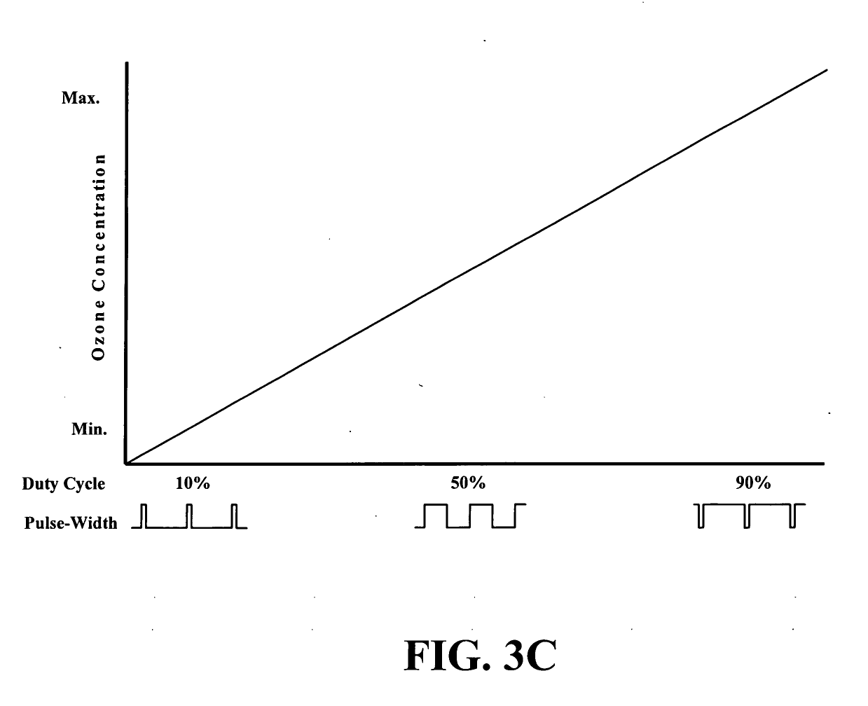

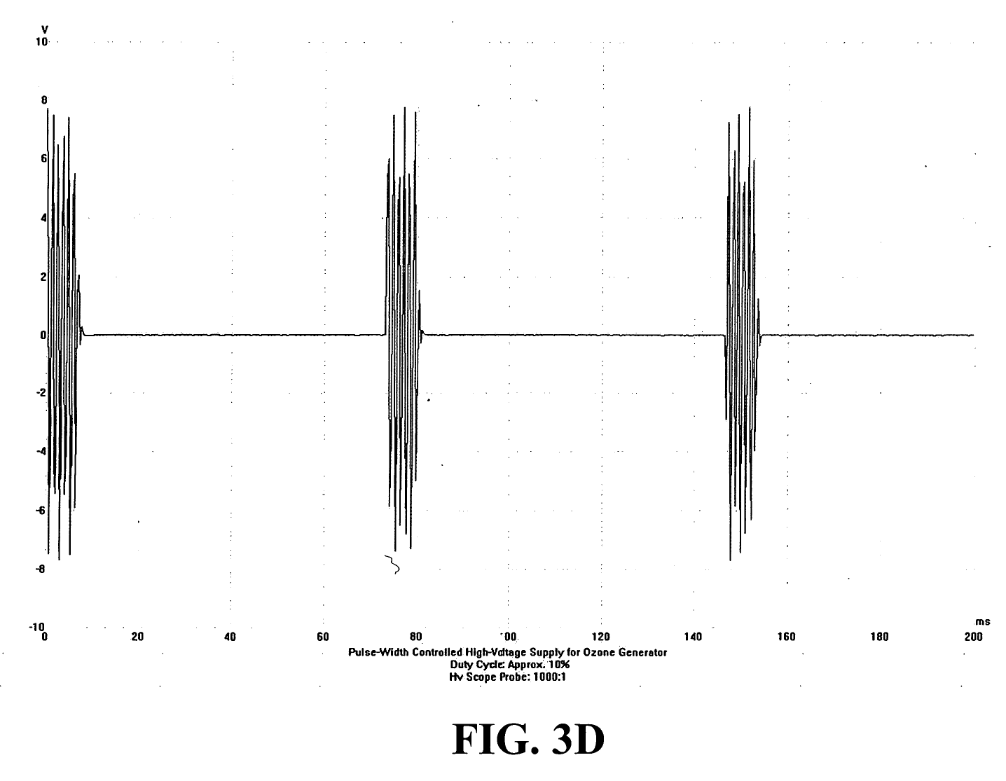

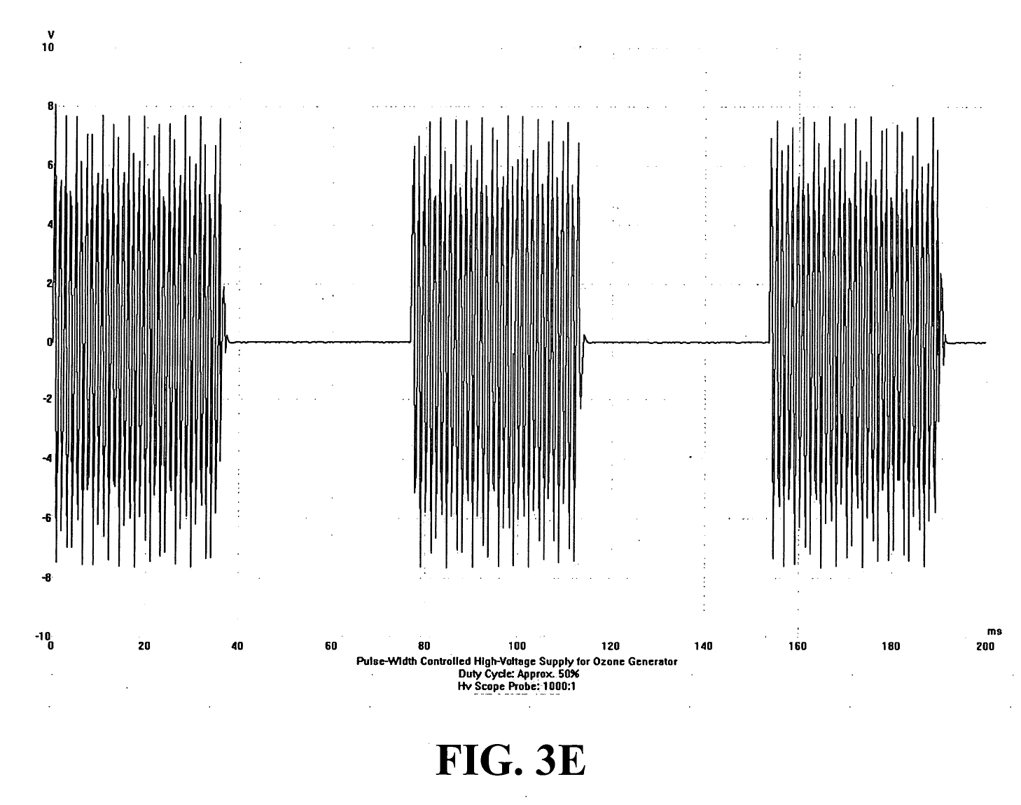

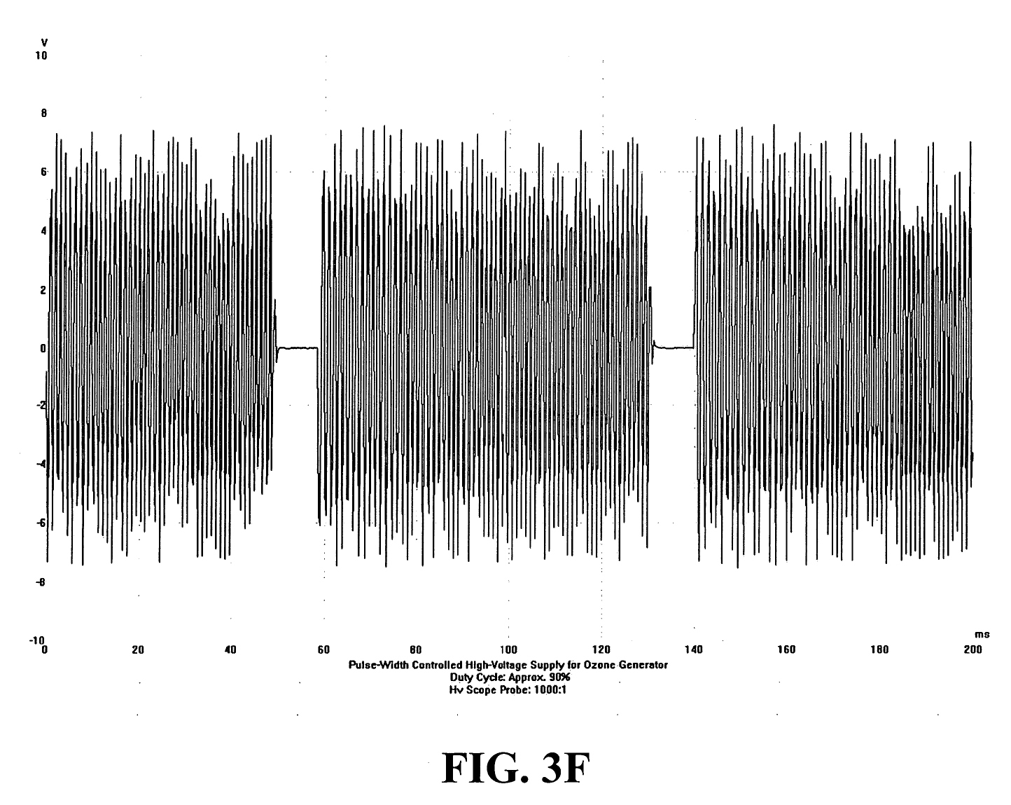

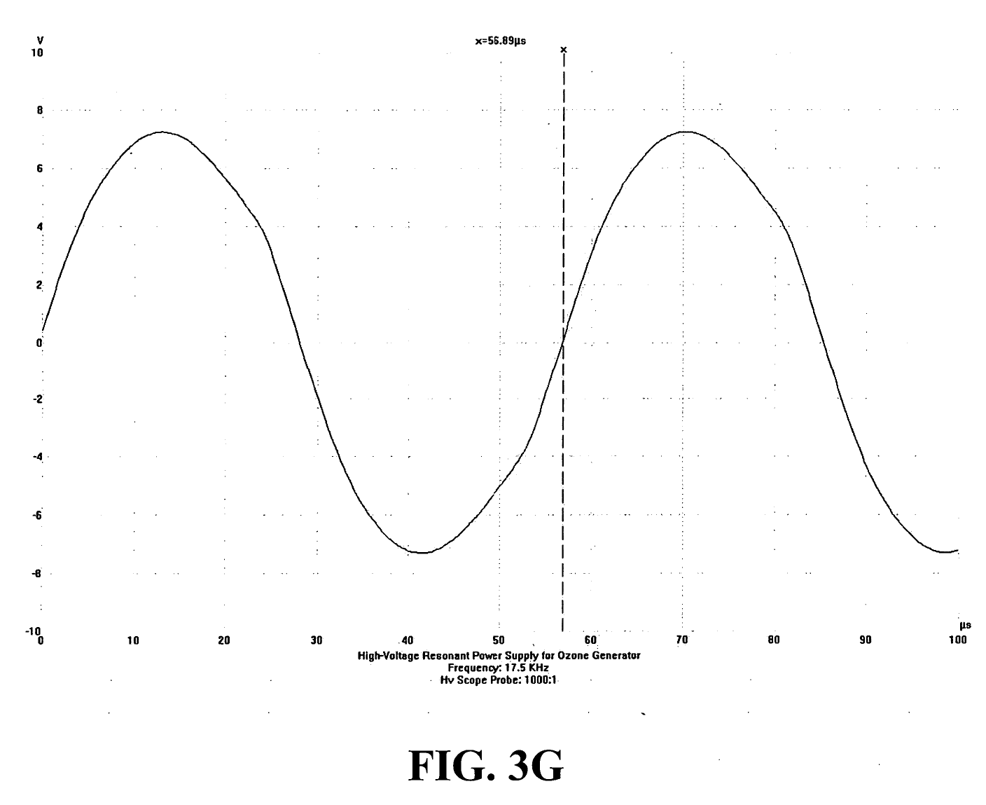

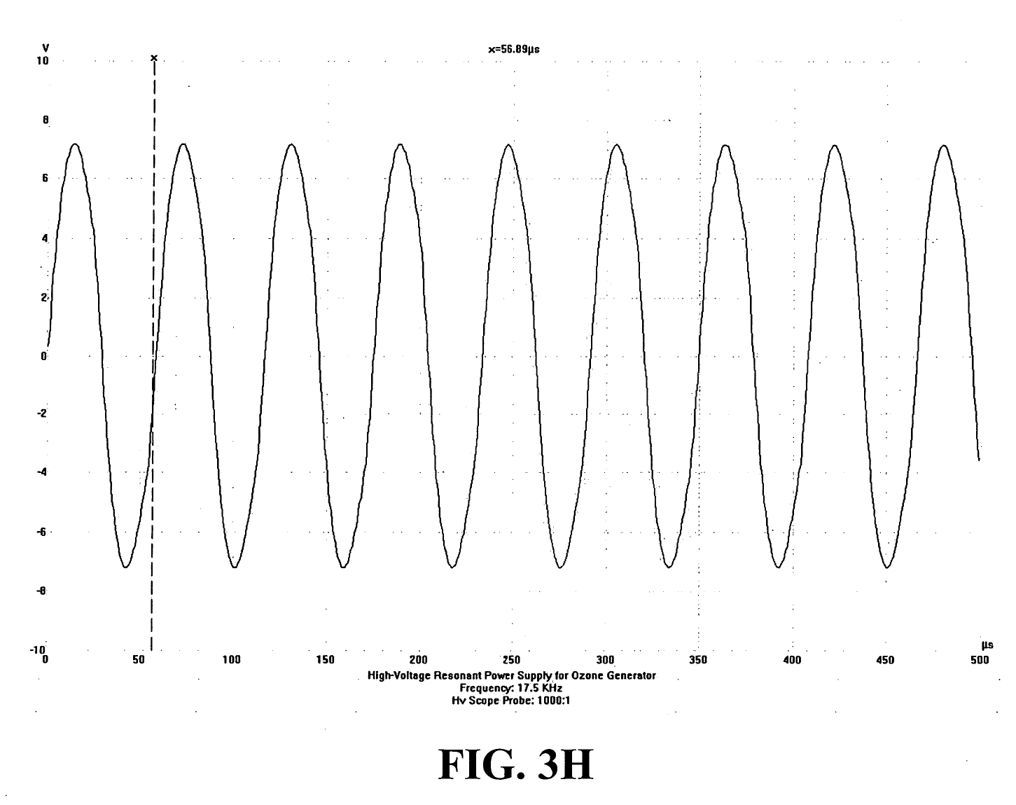

Referring now to FIG. 3A, a block diagram representing a preferred embodiment of an apparatus of this, generally 300, is shown to include a periodic high voltage system 302, an ozone cell 304 and a gas supply system 306. The periodic high voltage system 302 includes a pulse width control pulse generator 308 connected to a DC power supply 310 via an electrical connection 312 and to an RF high voltage power supply 314 via an electrical connection 316. The DC power supply 310 and the RF high voltage power supply 314 are also connected via an electrical connection 318. The system 302 also includes an impedance matching component 320 connected to the RF high voltage power supply 314, via an electrical connection 322. The system 302 is connected to the cell 304 via an electrical connection 324, which comprises to leads, one two each electrode. The gas supply system 306 includes a source of oxygen-containing gas 326 connected to a flow controller 328 via a gas line 330. The flow controller 328 is connected to the cell 304 via a gas line 332. The cell 304 also includes an ozone outlet 334.

Referring now to FIG. 3B, a block diagram representing another preferred embodiment of an apparatus of this, generally 350, is shown to include a periodic high voltage system 352, an ozone cell 354, a gas supply system 356 and an ozone detector 358. The periodic high voltage system 352 includes a pulse width control pulse modulation unit 360 connected to an RF high voltage power supply 362 via an electrical connection 364. The RF high voltage power supply 362 is connected to a DC power supply 366 via an electrical connection 368 and to an optional impedance matching component 370, via an electrical connection 372. The system 352 is connected to the cell 354 via an electrical connection 374, which comprises two leads, one to each electrode. The gas supply system 356 includes a source of oxygen-containing gas 376 connected to a flow controller 378 via a gas line 380. The flow controller 378 is connected to the cell 354 via a gas line 382. The cell 354 is connected to the ozone detector 358 via a gas line 384. The ozone detector 358 has an gas outlet 386 and is connected to the pulse width control pulse modulation unit 360 via an electrical connection 388.

Referring now to FIG. 3C, is a plot of the ozone concentration of the output gas compared to the duty cycle of the pulsed applied voltage to the cell 304. It is clear that the generators of this invention are capable of significant and dynamic adjustments of ozone concentrations in the output gas by simply changing the duty cycle of the supplied voltage across the cell electrodes. Looking the FIGS. 3D-F, individual plots of the actual form of the pulses generated by the power supply are shown. It is clear from the plots that the cycles are composed of a high frequency sine wave applied voltage. Looking a Figure G&H, plots of the substantially pure sine wave high frequency applied voltage from the power supply are shown at different scale factors. The frequency if about 17.4 kHz and the peak voltage is between about 6 and 8 volts.

Resonant High-Voltage Power Supply

Any AC power source with sufficient voltage to charge the quartz dielectric envelope and exceed the breakdown potential of the annular gap containing an oxygen bearing gas mixture, will induce an electrical discharge creating ionization and subsequent generation of ozone. However, different types of power supplies will produce ozone with varying degrees of efficiency and ozone concentration stability. Variables such as ozone cell geometry, inherent capacitance, the dielectric utilized, circuit impedance and design all play an active role.

The preferred embodiment of the invention utilizes a self-resonating, high-voltage power supply design, which operates in what is known as a push-pull configuration. The self-resonating design eliminates the need for an external oscillator, which both simplifies and increases the reliability of the intended circuit.

At the heart of most high-voltage power supplies utilized for ozone generation is a step up transformer which provides the applied voltage to induce discharge.

All transformers have a natural resonant frequency defined by the inductive, magnetic and geometric variables related to their design. Step-up transformers with magnetic cores can typically store more energy, but efficient, high-frequency operation is limited due to constraints involved in saturation and collapses of the magnetic field. Transformers with ferrite cores do not store as much energy as equivalent size magnetic cores, but efficiently operate at much higher resonant frequencies. However, as the frequency of a high voltage transformer is increased, the resonant peak profile becomes sharper and is more difficult to operate in the “sweet spot” or most efficient region. This can be problematic when utilizing the same power supply with various ozone cell designs possessing different capacitive loads.

A typical power supply design might include a capacitive discharge circuit, or a multi-vibrator whose output drives a high current switching transistor, that applies power to the primary winding of a step-up transformer. The frequency of the applied voltage may be defined by the RC time constant of the triggering circuit. Any change in the load of these circuits shifts the resonant frequency of the transformer, which would require re-tuning the applied switching frequency in order to maintain optimal efficiency under differing load conditions.

Ozone generator capacitance establishes primary circuit load and subsequent circuit resonance, which is influenced by geometry, size and the dielectric constant of the quartz, or other dielectric. Since the dielectric constant of quartz changes with temperature and the breakdown potential of the oxygen containing gas are affected by variations in both temperature and/or pressure, it should be apparent that as load conditions of the ozone chamber change, the ideal operating frequency must also change to maximize transformer efficiency under different operating conditions.

The proposed self-resonating, push-pull circuit design is an improvement over prior art in that it automatically compensates for any differences in power supply load. This circuit design allows the ideal or “peak” resonant frequency to be maintained, regardless of applied load conditions. Additionally, this circuit is capable of generating high-voltage with a near perfect sine-wave profile. This allows improved efficiency as it allows effective application of an impedance matching device, such as an inductor, to effectively “tune” the particular ozone cell to the resonant frequency of the high-voltage power supply circuit.

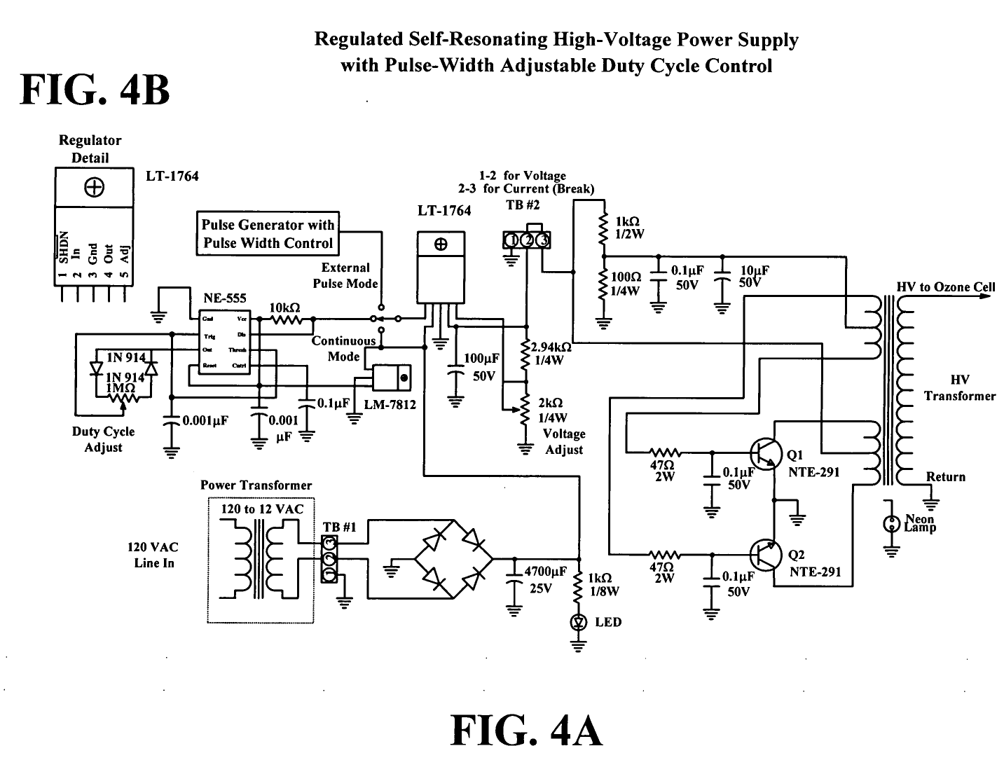

Two schematic of preferred embodiments of the power supply of this invention are shown in FIGS. 4A&B. In FIG. 4A, the circuit is shown without the impedance matching circuit component.

The primary winding is connected on opposite ends to the collector junctions of a pair of power transistors that alternately switch the DC supply voltage through opposite windings to ground. The base of each power transistor is connected to opposing ends of the center-tapped feedback windings. Oscillation occurs as the power transistors alternately saturate the ferrite core in opposite directions.

Although not to be bound by any theory, operation of drive circuitry begins when a small DC voltage applied to the center tap of the feedback winding applies a small current to the base of each of the power transistors that acts to “kick start” oscillation. Since no two transistors are exactly alike, one transistor begins to turn on before the other and creates a current imbalance. The first transistor to turn on forces the other transistor to turn off from current generated by the feedback winding.

For example, if transistor Q1 begins to turn on first, more current flows through the collector/emitter junction of the transistor Q1 and draws more current through the transistor Q1 side of the primary winding than through the transistor Q2 side of the primary winding as magnetic flux in the core begins to build. The rising magnetic flux will in turn begin to induce additional voltage and current in both the high voltage secondary, as well as feedback windings. The additional current generated in the feedback winding forces the transistor Q1 transistor to turn on even harder, which allows even more current to flow through the primary windings as the magnetic flux continues to build to the point of core saturation.

Once magnetic saturation of the transformer core occurs, the induced current in the feedback winding abruptly halts and reverses direction due to inductive transformer resonance or what is termed the “ringing effect”. Since the current from the feedback winding to the base of the transistor Q1 has reversed, the transistor Q2 begins to turn on and initiates a reversal of current direction through the primary windings. The induced current generated in the feedback windings are now directed to the base of the transistor Q2, allowing more current to now be drawn through the transistor Q2 side of the primary windings and further shuts down current flow through the transistor Q1. This in turn rapidly increases magnetic flux of opposite polarity within the core until it reaches saturation once again and the self-sustaining cycle begins to repeat. Since the saturation rate of the transformer core changes with load, the resonant frequency will always compensate or adjust itself to maintain the optimal operating frequency for different capacitive or reactive loads. In the disclosed circuit, the applied oscillating voltage is stepped up approximately 400:1 to obtain the desired voltage for discharge.

Voltage Regulation

The amount of ozone generated with a specified flow of the oxygen-containing gas can be increased by increasing the applied electrode voltage with a subsequent increase in power dissipation or heat generated within the cell, that can potentially compete with, or reduce overall ozone content due to the faster decay rate of ozone at higher temperatures. The high voltage power supply circuit includes a voltage regulator installed between the AC bridge-rectifier and transformer oscillation circuit to minimize fluctuations in the applied primary voltage due to potential variations in the AC power. This improvement acts to maintain a more constant peak-to-peak power supply discharge voltage, which directly influences the concentration and amount of ozone generated.

Pulse Width Control of Ozone Concentration

Typically, an ozone generator is designed to generate a specific amount of ozone (moles, grams, etc.) per unit time for the intended application. However, there are applications such as those required by various analytical methods where differing ozone concentrations may be desired without the need to change the design or capacity of the particular ozone generating cell. With previous embodiments ozone concentration is typically adjusted by changing the applied voltage or oxygen-containing gas flow to vary the dilution ratio of generated ozone. Of course, there is a lower limit to the amount of ozone that can be generated with a specified flow of oxygen containing gas with the same ozone generator. This lower limit is reached when the applied electrode voltage falls below the dielectric breakdown point of the gas.

However, there may be applications where it is desirable to change the ozone concentration without changing the gas flow. This may be particularly advantageous when the desired concentrations of ozone are very low to trace levels, which would generally require an excessive volume of gas, such as oxygen to be consumed. For these applications, a pulse-width control circuit can be used to adjust the time-averaged ozone concentration with any given ozone generator design, without changing total gas flow.

The pulse-width control circuit is a variable duty cycle, pulse generator that adjusts the duty cycle or time the high-voltage field is applied to the ozone generator cell. It is configured, for example, to inhibit ozone generation during the “off” portion of the cycle period, while still maintaining the minimum breakdown voltage of the oxygen or oxygen containing gas during the “on” portion of the cycle period. This allows the overall ozone concentration to be adjusted over a wide range between near-zero and the maximum allowed by the specific ozone generator design at a given oxygen or oxygen bearing gas flow rate. The current circuit embodiment includes a 555 multivibrator configured in a variable pulse width timing circuit, whose output is utilized to control the inhibit or “shutdown” pin (Pin 1) of an LT-1756 voltage regulator. The component values disclosed yield a logic-level timing frequency of approximately 10 Hz, whose duty cycle adjustment allows ozone production to be varied from less than 1% to greater than 99% of the ozone generating capacity of the cell design, without varying the dilution or change in the oxygen-containing gas flow rate.

All references cited herein are incorporated by reference. While this invention has been described fully and completely, it should be understood that, within the scope of the appended claims, the invention may be practiced otherwise than as specifically described. Although the invention has been disclosed with reference to its preferred embodiments, from reading this description those of skill in the art may appreciate changes and modification that may be made which do not depart from the scope and spirit of the invention as described above and claimed hereafter.

1. An ozone generator comprising:
an elongated closed tubular cell including:
an inner wall
an outer wall
an annular region
an annulus
an interior
a gas inlet and
a gas outlet,
an inner electrode adapted to be inserted into the annulus and position within the annular region so that the electrode is in contract with an inner surface of the inner wall of the cell,
an outer electrode adapted to surround a portion of the annular region, and
a power supply connected to the electrodes via electrical connections adapted to supply a periodic high voltage across the electrodes,
where an oxygen-containing gas is designed to flow through the interior of the cell from the inlet and outlet and where a concentration of ozone can be varied

2. The generator of claim 1, wherein the cell comprises a dual dielectric design that completely isolates the metal electrodes from the oxygen-containing gas flowing through the cell eliminating metal contamination of generated ozone.

3. The generator of claim 1, wherein the generated ozone is of high purity.

4. The generator of claim 1, wherein the generator generates a time averaged variable ozone concentration at constant flow rate, by utilizing a pulse width duty cycle to control an applied voltage.

5. The generator of claim 1, wherein the power supply comprises a self-oscillating, high-voltage electronic circuit which contains a current limiting output power resistor that limits maximum or peak discharge current to minimize production of undesired nitrogen oxides.

6. The generator of claim 1, wherein the power supply comprises a self-oscillating, high-voltage electronic circuit which contains a voltage regulator for better control of corona discharge and more stable ozone concentration.

7. The generator of claim 1, wherein the power supply comprises a self-oscillating, high-voltage electronic circuit which contains a circuit that allows the pulse width duty cycle of the applied voltage to be varied, enabling a wider range of ozone concentrations to be produced with a single ozone generator for multiple applications.

8. A method comprising the steps of:
supplying an oxygen-containing gas to the gas inlet of the cell of claims 1-7;
applying a periodic high voltage across the electrodes from the power supply producing periodic, short duration discharges through the oxygen-containing gas in the interior of the cell, where a frequency and pulse width of a duty cycle of the applied voltage controls an average ozone concentration produced in the oxygen-containing gas at a given oxygen gas flow rate; and
outputting an effluent gas with a desired average ozone concentration.

9. The method of claim 8, further comprising the step of;
varying the concentration of generated ozone by varying the frequency and pulse width of the duty cycle of the applied voltage according to a pre-established protocol or dynamically depending on the intended use or requirement of the system.

10. The method of claim 8, further comprising the step of:
impedance matching the power supply to tune a resonance frequency of circuitry in the power supply supplying the voltage to the electrodes for efficient and maximal energy transfer to the electrodes and ultimately to the oxygen-containing gas passing through the generator.

11. A method comprising the steps of:
generating ozone using an ozone generator of claims 1-7,
contacting the generated ozone with an ozone reactive analyte in a reaction chamber including a detector to generate electronically excited species;
detecting light emitted by the electronically excited species in a detector to produce an output signal;
forwarding the output signal to an analyzer that converts the detector signal into a concentration of an element in the analyte.

12. A method comprising the steps of:
generating ozone using an ozone generator of claim 1-7;
contacting the generated ozone with a gas stream containing SO₂ and an interfering concentration of NO at an effective ozone concentration, which is sufficient to convert all or substantially all of the interfering NO to non-interfering NO₂;
exposing the ozone treated gas to UV excitation light generated by a UV excitation light source to produce electronically excited SO₂ species, some of which subsequently fluoresce;
detecting the fluorescent light in a detector to produce an output signal; and
forwarding the output signal to an analyzer that converts the detector signal into a concentration of a sulfur in the gas stream.

13. A method comprising the steps of:
supplying a sufficient amount of ozone from an ozone generator of claims 1-7 to convert all or substantially all of all noxious oxidizable contaminants into less noxious or benign oxidized components in a waste stream;
varying the concentration of the generated ozone according to a pre-established protocol or dynamically depending on a concentration of noxious oxidizable components in the waste stream.
